(19) United States
(12) Patent Application Publication
(10) Pub. No.: US 2001/0030068 A1
(43) Pub. Date: Oct. 18, 2001

(54) Positively driven elastromeric track and suspension system for an agricultural tractor

(76) Inventors: James Nagorkca, Hamilton (AU); Murray Rogers, Hamilton (AU)

Correspondence Address: LARRY W. MILLER, NEW HOLLAND NORTH AMERICA , INC., P.O. BOX 1895, NEW HOLLAND, PA, 17557, US

(21) Appl. No.: 09/759,081

(22) Filed: Jan. 12, 2001

Related U.S. Application Data
(60) Provisional application No. 60/176,607, filed on Jan. 18, 2000.

(51) Int. Cl. B62D 6/00

(52) U.S. Cl. 180/6.2; 305/165

(57) ABSTRACT

The invention relates to a track and suspension system for an agricultural tractor. Invention consists of an endless rubber track encircling a drive wheel, front and rear idle wheels and a supporting undercarriage. The undercarriage has front and rear suspension arms supporting front and rear idler wheels. Movement of the suspension arms is limited and controlled by a bridge beam and a pair of air springs. The undercarriage also has mid track roller frames whose movement are limited and controlled by a bridge beam.

### CROSS-REFERENCE TO RELATED APPLICATIONS

This application claims domestic priority on U.S. Provisional Patent Application Ser. No. 60/176,607, filed on Jan. 18, 2000.

### BACKGROUND OF INVENTION

1. Field of Art

This invention relates to the improvement of an agricultural tractor. More specifically it relates to positively driven elastromeric track and suspension system for an agricultural tractor.

2. Description of Prior Art

Agricultural tractors have been used for a variety of farming operations for decades. Tractors have become more versatile and are now being used for a greater number of agricultural tasks. In order to minimize compaction to the soil a treaded is track is often used to support an agricultural tractor. The tracks offer the additional bonus that a tractor can be used in wet field conditions as opposed to a its wheeled counter-part. However, the use of treaded tractors creates new difficulties. Chief among these problems is maintaining track alignment and proper suspension for the tracked tractor.

The prior art illustrates these and additional difficulties. U.S. Pat. No. 5,279,378 to Caterpillar Inc or ‘Cat’ describes a heavy-duty belted farm tractor used in the Cat Challenger™ tractor. John Deere also manufactures the Deere 9000T™ that is a treaded tractor. Both the Deere 9000T™ and Cat Challenger™ tractors have differential steering which requires extra engine power to turn because the tractor ground speed is maintained and therefore the same pulling power is also required. The end result is that the operator has to reduce engine load to turn either by downshifting to a lower gear or raising the implement to reduce draft load. Case corp. manufactures a treaded tractor known as the Case-IH Quad Track™ tractor has articulated steering, but maneuverability is severely restricted to a large turn radius of 19′6″.

Consequently, the need exists for positively driven elastromeric track and suspension system for an agricultural tractor.

### OBJECTS OF THE INVENTION

It is an object of the present invention to provide a positively driven elastromeric track and suspension system for an agricultural tractor.

It is a further object of the present invention to provide a track and suspension system for a very a variety of tractors by means of a plurality of air springs.

It is a further object of the present invention to provide a track and suspension system capable of accommodating ground bumps and bridging ground hollows.

It is a further object of the present invention to provide a track and suspension system having two mid track frames that may move independently and a bridge beam that allows the mid track frames to have an upward vertical movement, but lacking a downward vertical movement.

### SUMMARY OF THE INVENTION

The invention overcomes the deficiencies of the prior art. The invention is track and suspension system for an agricultural tractor. The invention consists of an endless rubber or elastromeric track encircling a drive wheel, front and a rear idler wheels and two pairs of mid roller wheels and a supporting undercarriage. The undercarriage has front and rear suspension arms pivotally mounted to the front and rear axle, respectively. Attached to the front suspension arm is a front idler wheel, air spring, and front aligning member and track tension cylinder. Attached to the rear suspension arm is the rear idler wheel and another air spring. A pair of front mid track rollers is supported by a front mid track frame that is pivotally attached to the front aligning member. A pair of rear mid track rollers is supported by a rear mid track frame that is pivotally attached to the rear suspension arm. A bridge beam is pivotally attached to the front mid track frame. The bridge beam is pivotally connected to the rear mid track frame via a sliding shaft member. A sliding shaft member is pivotally connected to the rear mid track frame and engaged with the bridge below.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a general view of an agricultural tractor.

FIG. 2 is a side view of the positively driven elastromeric track and suspension system.

FIG. 3 is a graph illustrating the turning radius of a tractor in gears 1 through 12.

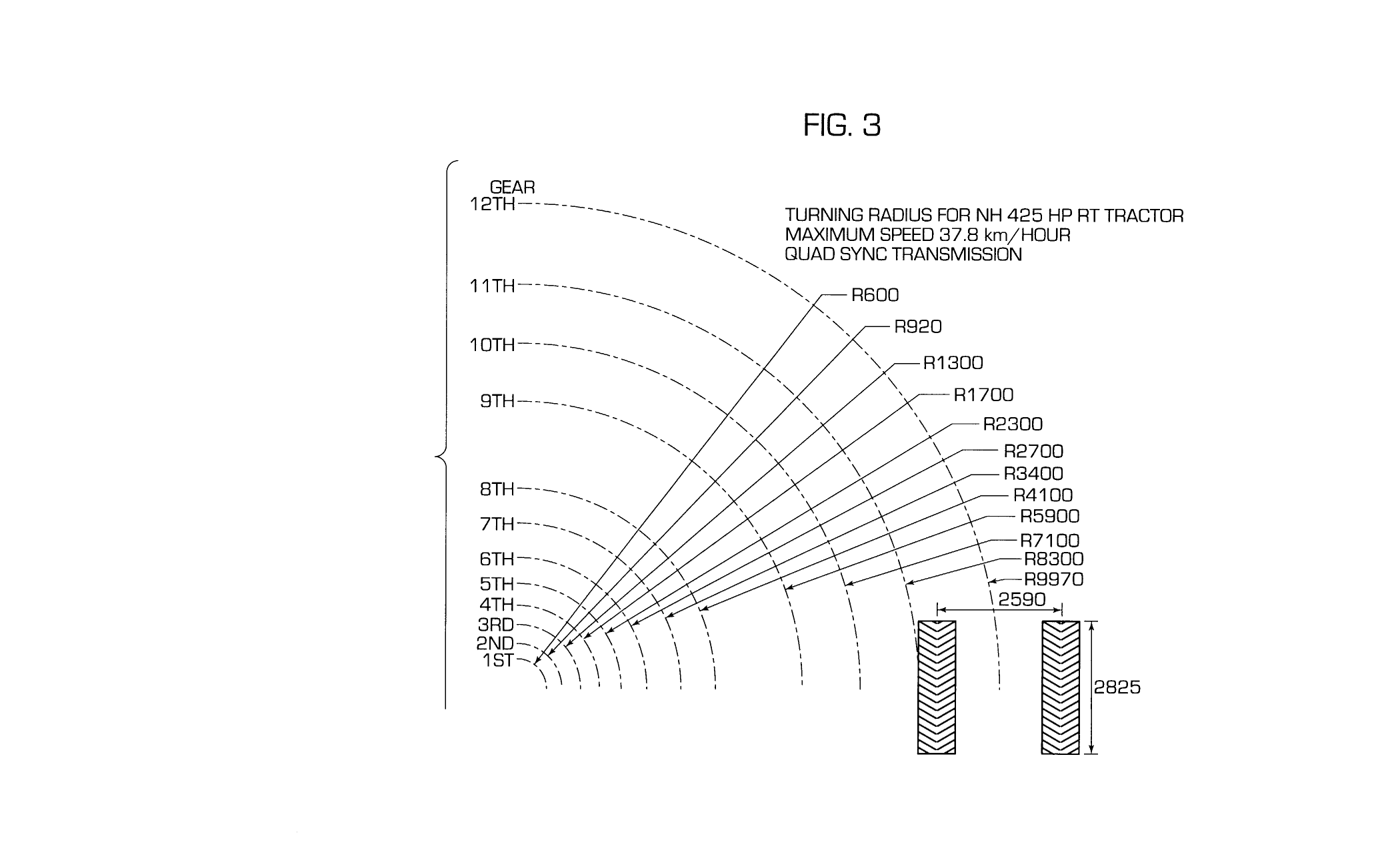

### DETAILED DESCRIPTION OF THE INVENTION

Referring to the drawings, it is possible to observe the major elements and general operation of the present invention. Left and right references are used as a matter of convenience and are determined by standing at the rear of the tractor and facing the forward end in the normal direction of travel. Likewise, forward and rearward are determined by normal direction of travel of the tractor. Upward or downward orientations are relative to the ground or operating surface. Horizontal or vertical planes are also relative to ground.

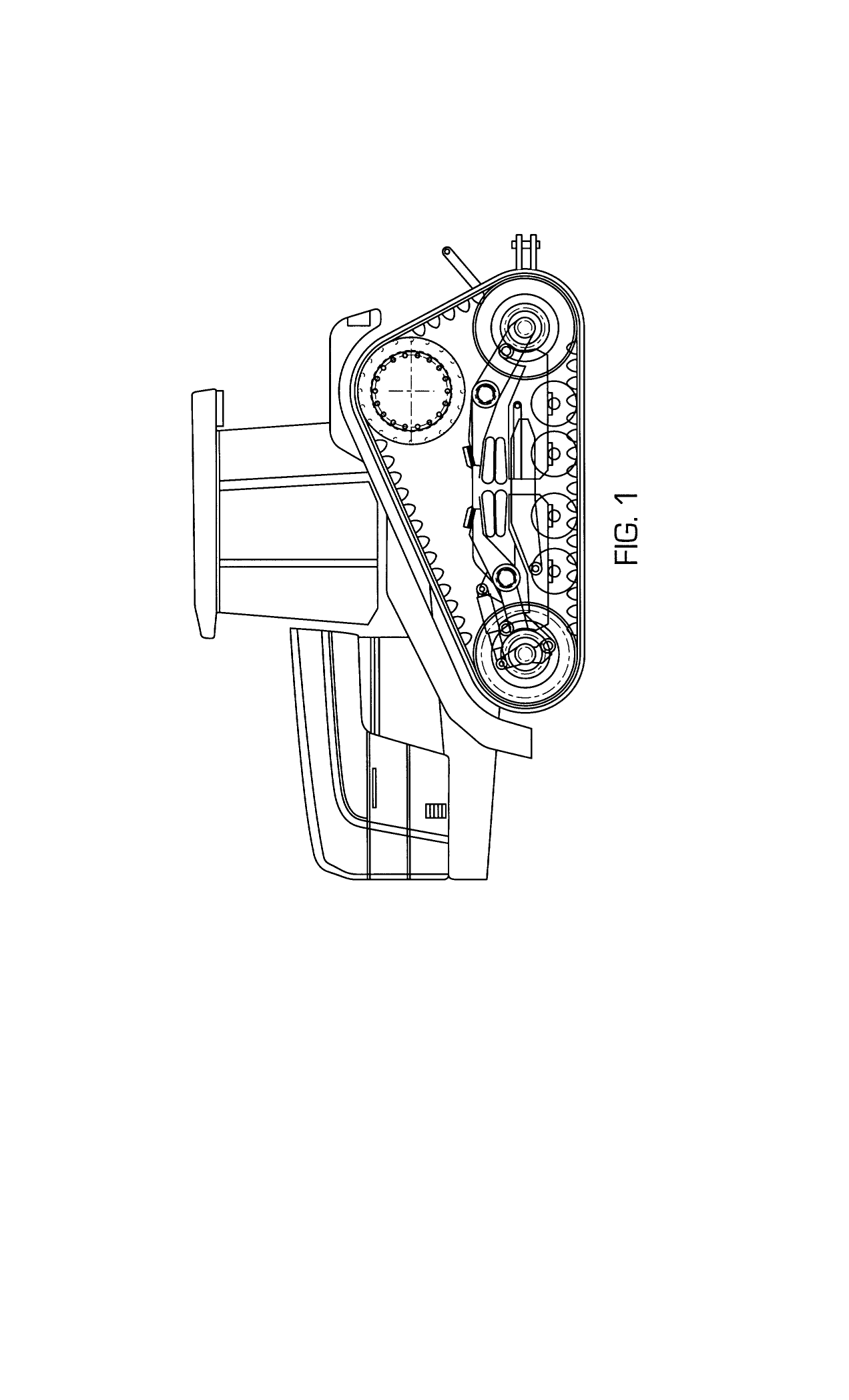

FIG. 1 illustrates a conventional agricultural tractor containing the present invention. The farm tractor has pair of elastromeric tracks (only one shown) for movement and the support of the remainder of the tractor. There is an engine compartment for supplying power. An operator's platform is reached by a series of platform steps and contains an operator's chair (not shown). From the operator's chair, the operator can observe and control a variety of farming operations. A steering wheel supported by a steering column is located in front of the operator's chair. There are a set of left-hand controls and right-hand controls for controlling the hitch, power-take-off (PTO) (not shown) and various other agricultural systems. The transmission housing 13 contains the transmission (not shown) which provide power to the tracks. The present invention focuses on the track and suspension system of the tractor.

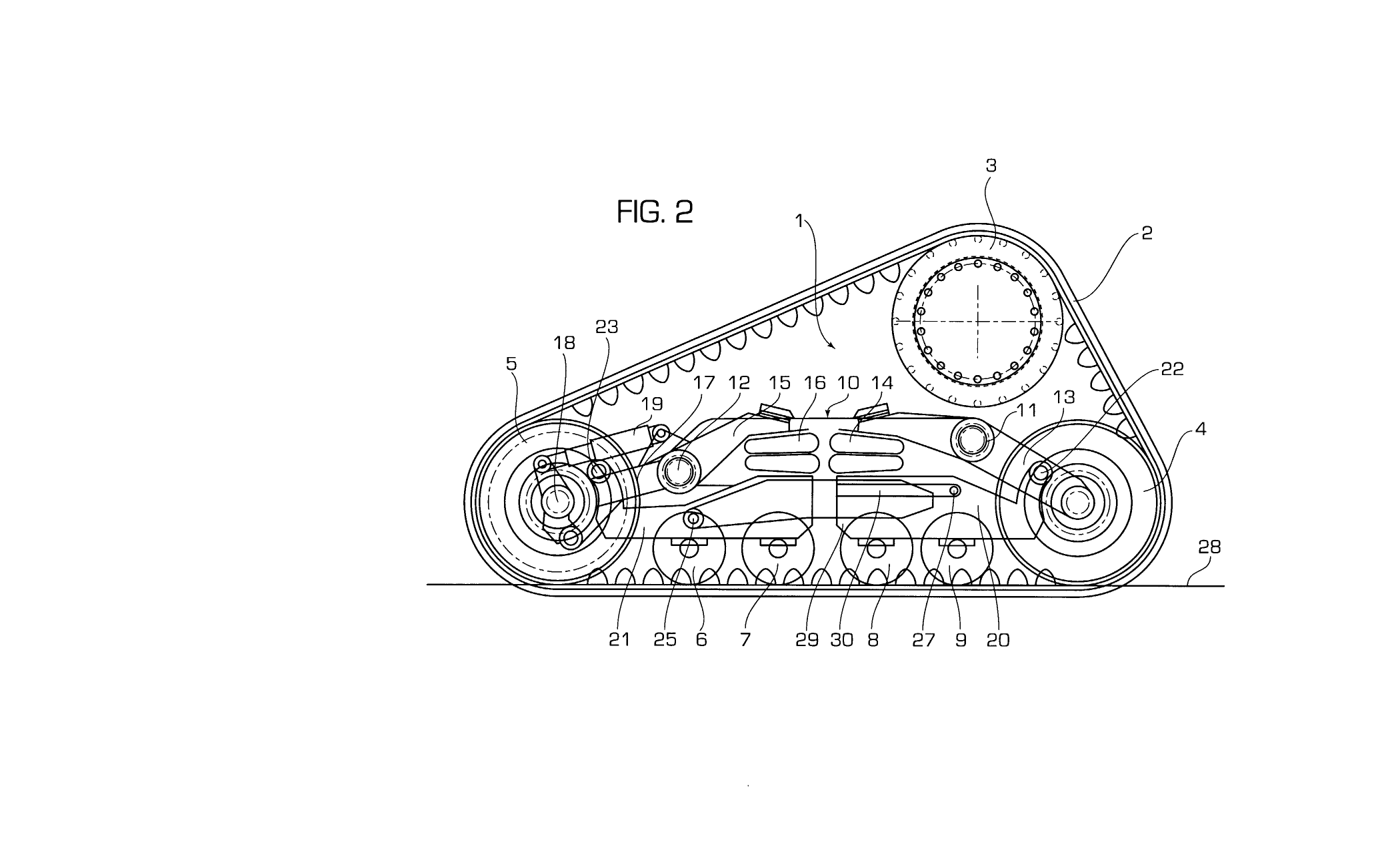

FIG. 2 illustrates the tractor track and frame 1, consisting of an endless rubber track 2, drive wheel 3, front and rear idler wheels 4 and 5, mid roller wheels 6, 7, 8 and 9, and supporting undercarriage components 10, connected to the tractor chassis by axle beams 11 and 12. Undercarriage components consist of a rear suspension arm 13 rotatably mounted to axle 11 and attached to arm 13 is idler wheel 4 and air spring 14. A front suspension arm 15 is rotatably mounted to front axle beam 12. Front suspension arm 15 has attached to its air spring 16, front aligning member 17, front axle 18, front wheel 5 and track tensioning cylinder 19. Mid track rollers 8 and 9 are supported by rear mid track frame 20 which is pivotally mounted to rear arm 13 by pin 22 and supported by air spring 14. Mid track rollers 6 and 7 are supported by front mid track frame 21 which is pivotally mounted to front aligning member 17 by pin 23 and supported by air spring 16. Bridge beam 24 is pivotally mounted to front mid track frame 21 by means of pin 25. Attached to bridge beam 24 is sliding shaft member 26 which is pivotally connected to rear mid track frame 20 by means of pin 27.

The novelty and features of this track suspension are the two mid track frame 20 and 21 which can move independently and vertically by pivoting around pins 22 and 23 and which support the vertical machine load by way of the air spring 14 and 16. Bridge beam 24 and its attached sliding shaft member 26 are a feature which only allows mid track frames 20 and 21 to move above plane 28 but does not allow downward vertical movement. The sliding shaft member 26 allows for fore/aft later movement between mid track frames 20 and 21 when vertical movement is required. Also there is fore/aft lateral movement of the mid track frames as the front and rear suspension arms 13 and 15 pivot around axle beams 11 and 12. Bumper stops 29 and 30 are placed between front mid track frame 21 and bridge beam 24 and between rear mid track frame 20 and siding shaft member 26. The bumper stops cushion the impact between the parts and because of the sliding movement of the shaft member 26 there is no siding or wearing of the bumper stops as the tow track frames move relative to each other. The two mid track frames accommodate “bumps” on the ground surface but bridge the “hollows” therefore allowing smoother ride and greater ground surface compliance without the fore/aft pitching.

The track system features a unique suspension system that gives a ride far superior to any other agricultural track machine, because no other machine has built-in suspension. The feature of the suspension is its ability to ride over the hollows and holes but compensate for the height of humps and bumps. The tractor literally rides on a cushion of air supported by four air springs. The suspension is gentle on the tractor and gentle on the operator. A much more comfortable ride is achieved at higher speeds than a tractor without suspension.

The track system front and rear suspension arms are positioned inside the track so that they are track tension and track load neutral. In other words, draught load and track tension does not effect suspension movement. Also visa-versa, suspension travel does not affect track tension.

The track system has built-in anti-dive that helps retain the tractor attitude during medium to heavy braking.

The suspension helps to further reduce soil compaction by reducing the impact of each track frame idler and roller wheel on the soil surface.

Extra tractive effort is gained on uneven ground due to the suspension movement keeping each track frame ground compliant.

The track system incorporates a twin hydro-mechanical steering system that allows the tractor to make full power turns under load without downshifting and/or engine lugging and stalling. Because every skid steer machine requires power to turn the steering power required is always added to the pulling power requirement when turning under load. Because the track system steering system reduces speed and therefore draft load in a turn, the total power required of the engine when turning is the same as straight ahead, or even reduced.

The track system steering automatically reduces tractor speed when turning. This is ideal for end of row turns when using mounted implements and saves wear and tear when turning with wide drawbar implements. John Deere and Cat tractors require constant downshifting and up shifting to achieve the same result.

Because of the outside track speed is maintained and the tractor speed is reduced on the track system when turning it is less likely that the outside track will “spin-out” or loose traction. With the Deere and Cat tractor differential steering the outside track increases its speed when turning. Because the outer track is also required to pull a higher draft load at an increased speed there is a much greater chance of track “spin-out”.

Steps that allow the operator access to the cabin are placed over the center of the left-hand track and can be easily moved in and out depending on tread spacing.

The track system tractor would be equipped with an air compressor and supply tank so that the operator is able to select optimum air pressure for the suspension air springs. A quick release air outlet is located at the rear of the tractor. This can also be used to clean remote outlets.

While the figure illustrates a large four-wheel drive tractor, the track and suspension system can be used on any land vehicle including smaller tractors; industrial tractors and skid steer loaders as well as harvesters.

It will be obvious to those skilled in the art that various changes may be made without departing from the scope of the invention and the invention is not to be considered limited to what is illustrated in the drawings and described in the specification.

What is claimed is:

1. A positively driven elastromeric track and suspension system for a land vehicle comprising:
a. an endless rubber track encircling a drive wheel, a front idler wheel and rear idler wheel;
b. a rear axle and a front axle supporting the agricultural tractor; and
c. a supporting undercarriage component pivotally attached to the rear axle and the front axle and the front idler wheel and rear idler rotationally attached to the undercarriage.

2. The track and suspension system described in claim 1, wherein the supporting undercarriage further comprises:
a. a front suspension arm coupled to the front axle and having the front idler wheel rotationally attached;
b. a rear suspension arm coupled to the rear axle and having the rear idler rotationally attached;
c. a rear mid track frame pivotally attached to the rear suspension arm;
d. a front aligning member attached to the front suspension arm; and
e. a front mid track frame pivotally attached to the front aligning member.

3. The track and suspension system described in claim 2, wherein the supporting undercarriage further comprises:
a. a first air spring and a track tensioning cylinder attached to the front suspension arm;
b. a first pair of mid roller wheels supported by the front mid track frame;
c. a second air spring attached to the rear suspension arm; and
d. a second pair of mid rollers supported by the rear mid track frame.

4. The track and suspension system described in claim 3, wherein the supporting undercarriage further comprises:
a. a bridge beam pivotally connected to the front mid track frame; and
b. a sliding shaft member attached to the bridge beam and pivotally connected to the rear mid track frame.

5. The track and suspension system described in claim 4, wherein the supporting undercarriage further comprises a first bumper stop positioned between the front mid track frame and the bridge beam and a second bumper stop positioned between the rear mid track frame and the sliding shaft member, wherein the position of the bumper stops allows upward vertical movement of the mid track frame but not downward vertical movement.

6. In a track and suspension system of an agricultural tractor, said tractor having a pair endless rubber tracks propelled by a drive wheel, said wheel propelled by a transmission, said transmission controlled by a shift lever system, said lever located on an operator's platform reached by a platform step, said platform having a steering wheel supported by a steering column, said platform also containing an operator's chair, a brake and a plurality of controls, the improvement comprising:
a. an endless rubber track encircling a drive wheel, a front idler wheel and rear idler wheel;
b. a rear axle and a front axle supporting the agricultural tractor;
c. a supporting undercarriage component pivotally attached to the rear axle and the front axle and the front idler wheel and rear idler rotationally attached to the undercarriage;
e. a front suspension arm coupled to the front axle and having the front idler wheel rotationally attached;
f. a rear suspension arm coupled to the rear axle and having the rear idler rotationally attached;
g. a rear mid track frame pivotally attached to the rear suspension arm;
h. a front aligning member attached to the front suspension arm;
i. a front mid track frame pivotally attached to the front aligning member
j. a first air spring and a track tensioning cylinder attached to the front suspension arm;
k. a first pair of mid roller wheels supported by the front mid track frame;
l. a second air spring attached to the rear suspension arm;
m. a second pair of mid rollers supported by the rear mid track frame;
n. a bridge beam pivotally connected to the front mid track frame; and
o. a sliding shaft member attached to the bridge beam and pivotally connected to the rear mid track frame, wherein the supporting undercarriage further comprises a first bumper stop positioned between the front mid track frame and the bridge beam and a second bumper stop positioned between the rear mid track frame and the siding shaft member

7. The improvement described in claim 6, wherein said tractor has an air compressor and a supply tank for supplying air pressure to the air springs.

8. The improvement described in claim 7, wherein the drive wheel is position above the front and rear idler wheels.

9. A positively driven rubber track and suspension system for an agricultural tractor comprising:
a. an endless rubber track encircling a drive wheel, a front idler wheel and rear idler wheel;
b. a rear axle and a front axle supporting the agricultural tractor; and
c. a supporting undercarriage component pivotally attached to the rear axle and the front axle and the front idler wheel and rear idler rotationally attached to the undercarriage;
d. a front suspension arm coupled to the front axle and having the front idler wheel rotationally attached;
e. a rear suspension arm coupled to the rear axle and having the rear idler rotationally attached;
f. a rear mid track frame pivotally attached to the rear suspension arm;
g. a front aligning member attached to the front suspension arm;
h. a front mid track frame pivotally attached to the front aligning member;
i. a first air spring and a track tensioning cylinder attached to the front suspension arm;
j. a first pair of mid roller wheels supported by the front mid track frame;
k. a second air spring attached to the rear suspension arm;
l. a second pair of mid rollers supported by the rear mid track frame;
m. a bridge beam pivotally connected to the front mid track frame; and
n. a sliding shaft member attached to the bridge beam and pivotally connected to the rear mid track frame.

10. A steering system wherein the total power required from an engine when turning a vehicle is the same as that when moving straight ahead, and wherein while turning, an inner wheel speed is reduced in an overall vehicle speed reduction.
